(19) United States
(12) Patent Application Publication
(10) Pub. No.: US 2016/0152839 A1
(43) Pub. Date: Jun. 2, 2016

(54) ANTIMICROBIAL COMPLEX SURFACE AND METHOD FOR FORMING THE SAME

(71) Applicant: CATCHER TECHNOLOGY CO., LTD., Tainan City (TW)

(72) Inventors: FENG-JU LAI, TAIPEI CITY (TW); CHUNG-CHENG LIN, TAICHUNG CITY (TW)

(21) Appl. No.: 14/612,400

(22) Filed: Feb. 3, 2015

(30) Foreign Application Priority Data
Nov. 28, 2014 (TW) 103141457

(51) Int. Cl. C09D 5/14; C25D 11/08; C25D 11/02; C25D 11/18; C25D 11/04; C25D 11/16; C25D 11/10

(52) U.S. Cl. CPC C09D 5/14; C25D 11/16; C25D 11/08; C25D 11/10; C25D 11/18; C25D 11/04; C25D 11/024

(57) ABSTRACT

Method for forming antimicrobial complex surface, being performed during processes of an anodic treatment including the following steps being worked on a workpiece: pretreatment, anodization, acid pickling, staining and pole sealing, at least comprising the following steps: providing an silver containing solution; introducing the silver solution during the processes of the anodic treatment; and providing silver particles based on the silver solution as an silver particle source, so as to form an antimicrobial complex surface on the workpiece.

### BACKGROUND OF THE INVENTION

1. Field of the Invention

The instant disclosure relates to an antimicrobial complex surface and method for forming the same; in particular, to an anodized complex surface that undergoes special treatment to suppress bacteria or microorganism growth on the complex surface and a method forming the same.

2. Description of Related Art

Anodization of metals typically refers to the electrolysis of metals such as aluminum or aluminum alloy in order to form an oxidized film on a surface, broadly known as anodized aluminum. After being anodized, the oxide film on the surface is a non-continuous aluminum oxide layer that can be resistant to corrosion, and provide advantages such as enhanced paint adhesion, electrical insulation, and abrasion-resistance. The aluminum oxide layer has a plurality of porous microstructures, which is why the anodized aluminum is widely used to for surfacing general electronics, home appliances, furniture, consumer goods, and many other housing products.

However, since anodized aluminum is often used on the housing, handles, and buttons of handheld mobile devices, ATM machines, and devices that frequently encounter dermal contact without being sufficiently sanitized, bacteria such as S. aureus (Staphylococcus aureus) or E. coli (Escherichia coli) can be easily spread to other users via dermal contact with the devices, rendering the anodized aluminum surface a bacteria, microbes, or even causative pathogen spreading media. However, conventional methods for resistance against microbial growth on the anodized aluminum surface are ineffective due to the antimicrobial materials not being properly formed or distributed on the surface, thus rendering the microbial surface ineffective. Moreover, the existing advantages of anodized aluminum surfaces may be significantly affected by disadvantages such as color deterioration where the antimicrobial materials used are not compatible with the dyeing materials that result in the deterioration of the original color.

To address the above issues, the inventor strives via associated experience and research to present the instant disclosure, which can effectively improve the limitation described above.

### SUMMARY OF THE INVENTION

The objective of the instant disclosure is to provide an antimicrobial complex surface and the method for forming the same in order to improve upon the micro-organic growth in current complex surfaces and retain the advantages of the complex surface while continuing to inhibit micro-organic growth activities.

In order to achieve the aforementioned objectives, according to an embodiment of the instant disclosure, a processing method to form an antimicrobial complex surface is provided. The method is executed during an anodic treatment, in which the anodic treatment is performed onto a workpiece and is comprised of the following steps in sequence: pretreatment, anodization, acid pickling, staining, and sealing. The processing method for forming the antimicrobial complex surface includes at the least the following steps: providing a silver containing solution, add the silver containing solution during the anodic treatment, and provide a plurality of silver particles with the silver containing solution as a source of silver particles so that the complex surface is comprised of silver particles.

In order to achieve the aforementioned objectives, according to an embodiment of the instant disclosure, an antimicrobial complex surface is provided and formed on the outer surface of a workpiece. The complex surface includes an anodized first metal complex surface, and a plurality of silver particles. The first metal complex surface is distributed on the outer surface of the workpiece according to a first distribution region while the first complex surface has a first porous microstructure

In summary, the first porous microstructure formed on the first metal complex surface along with the silver particles can be distributed on the workpiece according to the first distributing region. Distribution areas can further extend to the outer surface of the first metal complex surface, in the first porous microstructure of the first metal complex surface, or on the sealing layer that seals the first porous microstructure. The antimicrobial complex surface does not affect the advantages that exist in the original first metal complex surface, while retaining staining and antimicrobial effects.

In order to further understand the instant disclosure, the following embodiments and illustrations are provided. However, the detailed description and drawings are merely illustrative of the disclosure, rather than limiting the scope being defined by the appended claims and equivalents thereof.

### BRIEF DESCRIPTION OF THE DRAWINGS

FIG. 1A is a process flow diagram of a method to form an antimicrobial complex surface in accordance with the instant disclosure;

FIG. 1B is a process flow diagram illustrating the preparation of a nano-silver solution of the method in accordance with the instant disclosure;

FIG. 2A to 2D are cross-sectional views illustrating the structure and changes applied to the antimicrobial complex surface formed in accordance with the instant disclosure;

FIG. 3 is a cross-sectional view illustrating the structure of the antimicrobial complex surface formed in accordance with another embodiment of the instant disclosure;

FIG. 4A is a process flow diagram illustrating the steps of an anodic treatment used in the method in accordance with the instant disclosure;

FIG. 4B is a process flow diagram illustrating the steps of the method in accordance with the instant disclosure;

FIG. 4C is a process flow diagram illustrating the steps of the anodization of the method in accordance with the instant disclosure;

FIG. 4D is a process flow diagram illustrating the steps of the staining to provide an antimicrobial complex surface in accordance with the instant disclosure;

FIG. 4E is a process flow diagram illustrating the steps of immersion into a silver suspension solution to provide an antimicrobial complex surface in accordance with the instant disclosure;

FIG. 5A is a schematic diagram illustrating a workpiece being processed in an electrolyzer in accordance with the instant disclosure;

FIG. 5B is another schematic diagram illustrating a workpiece being processed in an electrolyzer in accordance with the instant disclosure; and

FIG. 5C is a schematic diagram illustrating the application of a reflex (positive-negative pulse) voltage in accordance with the instant disclosure.

### DETAILED DESCRIPTION OF THE PREFERRED EMBODIMENTS

The aforementioned illustrations and detailed descriptions are exemplarity for the purpose of further explaining the scope of the instant disclosure. Other objectives and advantages related to the instant disclosure will be illustrated in the subsequent descriptions and appended drawings.

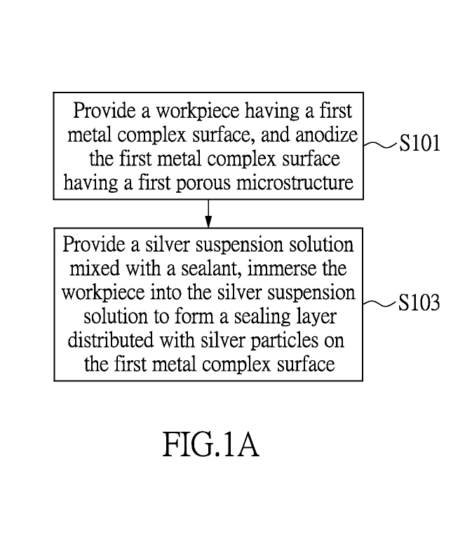

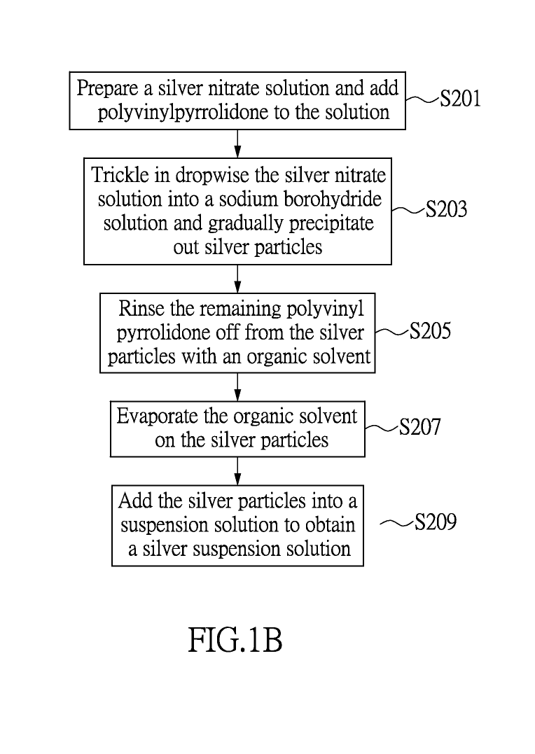

FIG. 1A is a process flow diagram of a method to form an antimicrobial complex surface in accordance with the instant disclosure, and the method includes the following steps.

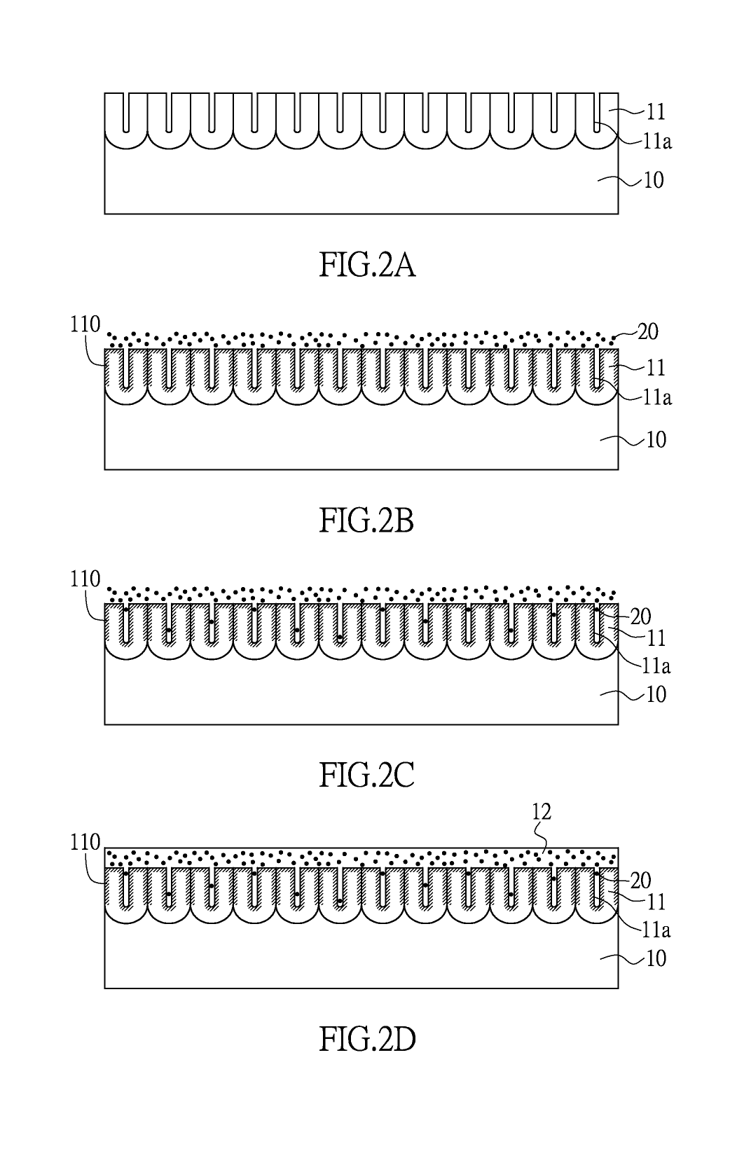

With reference to FIG. 2A, a cross-sectional view illustrating the structure and changes applied to the antimicrobial complex surface formed in accordance with the instant disclosure, Step 101 includes that a workpiece 10 is provided. The workpiece can be any item for processing, such as the housing for a mobile phone that is mostly manufactured by aluminum or aluminum alloys, but is not limited thereto. The workpiece 10 can have an anodized first metal complex surface or outer surface 11. Preferably, the first metal complex surface 11 can first be formed on the workpiece 10 according to a first distribution region, and the first metal complex surface 11 has a porous microstructure 11a after being anodized. Since the first metal complex surface 11 has already been anodically oxidized or anodized, the first metal complex surface is relatively an oxidized film. Although the preferred embodiment forms the first porous microstructure 11a on the upper outer surface of the workpiece 10, however, the microstructure 11a can be formed on the upper outer surface (not labeled) or a lower outer surface (not labeled) of the workpiece 10 by anodization, and is not limited by the examples provided herein. Preferably, the workpiece 10 can be of special shapes and forms as necessary by design, for example, the workpiece 10 can first be machine processed. Preferably, the workpiece 10 can be processed by computer numerical control (CNC) to further provide the visual effect of surface treatment. Notably, the workpiece 10 can also undergo a single or numerous pretreatment processes before being anodized, in which the quantity of pretreatments depends on the quality that is required on the aluminum alloy workpiece. The pretreatment can be, but are not limited to, degreasing, alkaline etching, first pickling, chemical polishing, a second pickling, and similar processes. After each pretreatment, the workpiece 10 undergoes one to five washing or rinsing processes, with a preference at two washes, to remove any chemical or contaminant that still remains on the workpiece 10 from the previous wash. The parameters on which the aforementioned pretreatment processes depend and the ways the processes are used are adjusted based on the workpiece 10, and the parameters and the ways of the processes are not limited by the examples provided herein.

With reference to FIG. 2B, a cross-sectional view illustrating the structure and changes applied to the antimicrobial complex surface formed in accordance with the instant disclosure, Step 103 includes that a silver suspension solution (not shown and labeled) is provided. The silver suspension solution is mixed with a sealing agent to form a processing solution. In other words, the silver suspension solution is a processing solution that can be a suspension solution mixed with silver particles and sealing agent. The workpiece 10 is immersed into the silver suspension solution so that the silver particles 20 are absorbed onto the first metal complex surface 11 of the workpiece 10. Notably, the first metal complex surface 11 and the porous microstructure 11a will be slightly positive after anodization. When the silver particles 20 are neutrally charged, the silver suspension solution can also be mixed with an anionic surfactant. The anionic surfactant has a weight percent between 0 to 8% of the total mixture weight. The anionic surfactant can further envelop the silver particles 20 in a solution state, thus rendering the charge of the silver particles 20 slightly negative. The slightly negative silver particles 20 can further help absorb the particles onto the first metal complex surface 11 in comparison to the neutrally charged silver particles. To further improve absorption of the particles onto the first metal complex surface 11, the workpiece 10 is immersed into the silver suspension solution for an extended amount of time under heating at a temperature ranging from 80 to 100° C., in which the longer the workpiece 10 is submerged, the higher the absorption. The preferred submersion time ranges from 10 to 60 minutes. The anionic surfactant is preferably sodium dodecylbenzenesulfonate or sodium dodecyl sulfate (SDS), or similar chemicals.

The sealing agent can be compounded with silver particles 20 to deposit onto the first metal complex surface 11 to form a sealing layer 12, so that the silver particles are distributed throughout the sealing layer 12. In this step, the sealing agent is preferably a nickel acetate based sealing agent. In other words, the sealing layer 12 can be a nickel sealing layer. Notably, since the silver particles 20 are already attached on the first metal complex surface 11 at the beginning of the step S103, the silver particles 20 can be mixed into the sealing layer 12 when the sealing agent is added in the course of forming the sealing layer 12, thus the silver particles 20 and the sealing layer 12 together can be deposited onto the first metal complex surface 11. According to X-ray fluorescence (XFR) analysis, the silver particles 20 illustrate a composition of 0.001% to 10% weight in the sealing layer 12.

Moreover, please refer to FIG. 1B as the process flow diagram illustrating the preparation of a silver suspension solution of the method in accordance with the instant disclosure. The silver suspension solution is prepared by the following steps. Step S201: prepare a silver nitrate solution having a molar concentration from 0.01 M to 0.1 M, preferably at 0.01172M (such as a solution composed of 0.36 g of silver nitrate and 180 ml of water). Adding sufficient polyvinyl pyrrolidone (PVP) into the silver nitrate solution to obtain a solution that accounts for a PVP weight percent range from 0.027 to 0.054% of the silver nitrate solution, thus the concentration of the silver nitrate is not limited to 0.01172M. Notably, high concentration of all aforementioned agents is not recommended as silver in the solution can excessively accumulate leaving the particle size too large.

Step S203: Trickle in dropwise the silver nitrate solution into a sodium borohydride solution (NaBH₄). The sodium borohydride has a molar concentration of 0.00846M to 0.01M in the sodium borohydride solution, which can be prepared for example by 0.16 gram of sodium borohydride added with 500 ml of water but is not limited to the example provided herein. The silver nitrate solution can then gradually precipitate out the nano silver particles. Notably, “trickle in” is essential to obtain relatively small particle sized silver particles due to the fact that silver particles tend to accumulate and aggregate into a larger particle when a large quantity of the silver particles are being precipitated out in a short amount of time. In order to further ensure the particle size of the silver particles are relatively small, trickling the silver nitrate solution into sodium borohydride solution can be performed at a low temperature between 4 to 10° C. to reduce the rate of precipitation, to subsequently prevent excessive aggregation of the silver particles due to excessive precipitation per unit time, and prevent the particle size being too large.

Step S205: Obtain the silver particles through filtering and subsequently rinsing or washing the remaining polyvinyl pyrrolidone off from the silver particles with an organic solvent. The organic solvent can be an alcohol such as methanol or ethanol. Step S207: Evaporate the organic solvent on the silver particles. Organic solvent tends to remain with the silver particles after rinsing, thus, the silver particles further undergo vacuum distillation to quicken and supplement evaporation of the organic solvent thereon, otherwise, unevaporated organic solvent can lead to excessive aggregation of the silver particles that generate large particle sized silver particles. Step S209: The aforementioned silver particles are added to a suspension solvent to obtain the silver suspension solution. The suspended silver particles (silver particles 20 as shown in FIGS. 2A to 2D) are nano-silver particles of particle size ranging from 10 to 500 nanometers (nm).

Please refer to FIGS. 1A and 2D. Preferably, the anodized first metal complex surface 11 can further undergo a staining process such as submerging the workpiece 10 into an anodizing solution having a sulfuric acid concentration of 20 to 25% with a voltage applied between 10 to 16 volts, current density between 0.8 to 2.0 A/dm² (ampere/square decimeter), and a treatment time less than 45 minutes. The preferred treatment time is less than 30 minutes. After anodization, a first staining process is performed on the first metal complex surface 11. The first staining process can be done through color absorption or chemical coloring, so that the anodized first metal complex surface 11 becomes a first oxidized film having a first color. In other words, the first oxidized film is equivalent to a first color layer, which jointly distributes the first color on the first metal complex surface 11 and into the porous microstructure 11a of the first metal complex surface 11. Consequently, the sealing layer 12 envelops the silver particles as well as the first oxidized film having the first color during the sealing step.

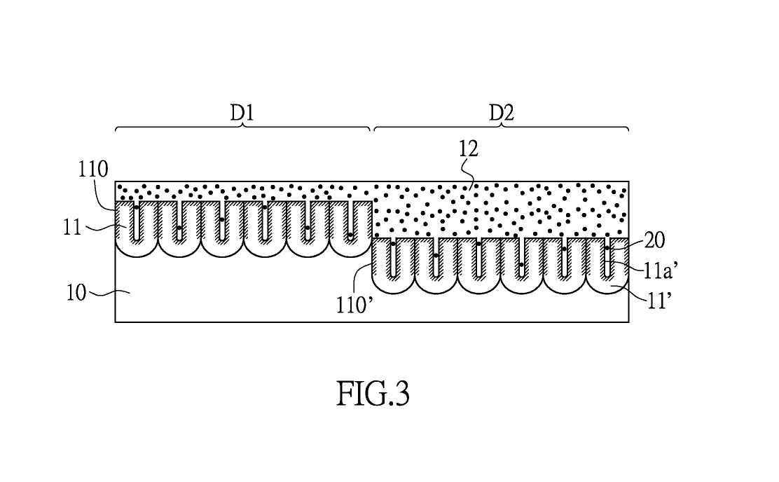

Multiple staining processes can be performed to accommodate different kinds of colors as desired. In order to do so, a portion of the first metal complex surface 11 must be removed (such as via CNC) from the outer surface of the workpiece 10 to expose the portions of the workpiece 10 that have not been oxidized, to facilitate an additional anodization to the portions of the workpiece 10 without the first metal complex surface 11 thereon, and to subsequently form a second metal complex surface 11′ (as shown in FIG. 3). The additional anodization can be performed at a temperature ranging from 15 to below 25° C., while the workpiece 10 is submerged into an anodizing solution having a sulfuric acid concentration of 20 to 25% with a voltage applied between 6 to 25 volts, and a processing time from 1 to 20 minutes. Then another staining process, such as color absorption or chemical coloring, is performed, so that the second metal complex surface 11′ of the workpiece 10 can include a second oxidized film having a second color. In other words, the second oxidized film is equivalent to a second color layer 110′. Successively, proceed to the aforementioned step S103.

Please refer to FIG. 2D in conjunction with method above. The instant disclosure provides an antimicrobial complex surface that is formed on an outer surface of a workpiece 10. The antimicrobial complex surface at least includes an anodized first metal complex surface 11, and a sealing layer 12. Preferably, the first metal complex surface 11 can be distributed on the outer surface of the workpiece 10 according to a first distribution region (not shown or labeled), and the first metal complex surface 11 has a first porous microstructure 11a. The workpiece 10 can be an aluminum or an aluminum alloy workpiece.

The sealing layer 12 is entrained with a plurality of silver particles 20, formed on the first metal complex surface 11, and seals over the first porous microstructure 11a. Preferably, the sealing layer 12 is a nickel acetate based sealing agent, in other words, a nickel acetate based sealing agent forms the sealing layer 12, so that the sealing layer 12 and the first metal complex surface 11 clad and combine to form a corrosive resistant first metal complex surface 11 and a sealing layer 12 of a composite metal surface having corrosive resistance. A nickel acetate based sealing layer 12 is sealed at a processing temperature ranging from 80 to 99° C., and a processing time ranging from 1 to 30 minutes. The workpiece is then dried. In other words, the sealing layer 12 can be a sealing nickel layer. The first metal complex surface 11 can have a first color layer 110 (equivalent to the aforementioned first oxidized film) demonstrating (or having) a first color after being stained.

As shown in FIG. 3, the antimicrobial complex surface can also include a second metal complex surface 11′ that is distributed on the outer surface of the workpiece 10 and proximate to the first metal complex surface 11 according to a second distribution region D2. As shown in the cross-sectional view in FIG. 3, the second metal complex surface 11′ can be at a position lower than the first metal complex surface 11. Similar to the first metal complex surface 11, the second metal complex surface 11′ can also have a second porous microstructure 11a′. The sealing layer 12 can also be entrained with silver particles, formed on the second metal complex surface 11′, and sealed over the second porous microstructure 11a′. Similarly, the second metal complex surface 11′ can also have a second color layer 110′ (equivalent to the aforementioned second oxidized film) that demonstrates a second color after the second complex surface 11′ is stained.

Based on the embodiments above, the outer surface of the workpiece 10 has a silver weight percent of 0.01% of the total weight, which is compliant to the standard of SGS Taiwan Ltd in regards to the silver content that can achieve antimicrobial effect. According to actual results obtained from antimicrobial testing by SGS, outer surfaces of workpieces that are treated with the method provided in the instant disclosure indeed inhibit the activity of microbial growth. The following chart I and II demonstrates the actual testing results.

CHART I
Test Strain: Staphylococcus aureus ATCC 6538P

| | | | Antimicrobial |
|---|---|---|---|
| Test Group | CFU/cm² | LOG | Value (R) |
| A | 1.3 × 10⁴ | 4.11 | >5.18 |
| B | 9.5 × 10⁴ | 4.98 | |
| C | <0.63 | −0.2 | |

CHART II
Test Strain: Escherichia coli ATCC 8739

| | | | Antimicrobial |
|---|---|---|---|
| Test Group | CFU/cm² | LOG | Value (R) |
| A | 1.2 × 10⁴ | 4.08 | >5.87 |
| B | 4.7 × 10⁵ | 5.67 | |
| C | <0.63 | −0.2 | |

In chart I, Staphylococcus aureus (CCRC code: ATCC 6538P) is used as a representative of the Gram-positive bacteria class for the antimicrobial testing, while Escherichia coli (CCRC code: ATCC 8739) is used as a representative of the Gram-negative bacteria class in the antimicrobial testing as shown in chart II. The test groups A in chart I and II represent the unprocessed workpieces and the number of bacteria measured immediately after inoculation, where the units are in CFU/cm² (Colony-Forming Unit/cm²). The test groups B represent the unprocessed workpiece, and the number of bacteria measured after inoculation and 24 hours of incubation. The test groups C represent the processed workpiece by the method of the instant disclosure, and the number of bacteria measured after inoculation and 24 hours of incubation. The antimicrobial value (R) is obtained by dividing the value of test group B by the value of test group C, and then taking the logarithmic of the value resulting from the division. According to SGS, if the antimicrobial value (R) is greater than 2.0, an antimicrobial effect is achieved. Consequently, consistent results that are obtained after three repeated tests illustrate that the method and the antimicrobial complex surface of the instant disclosure truly provide an antimicrobial effect.

### Second Embodiment

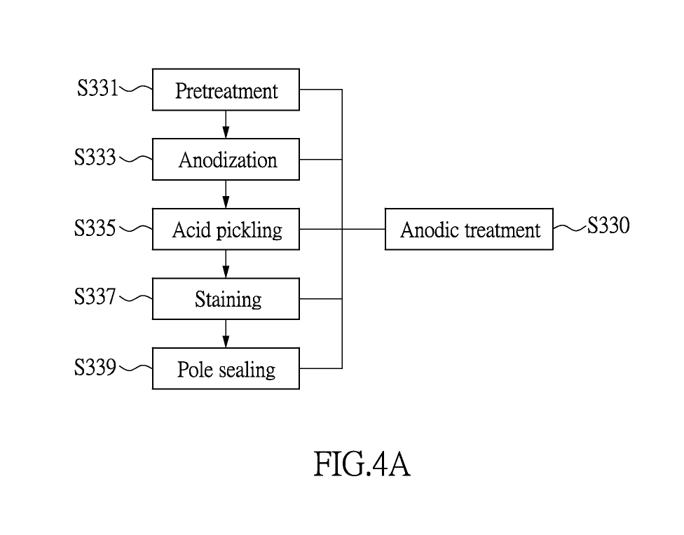

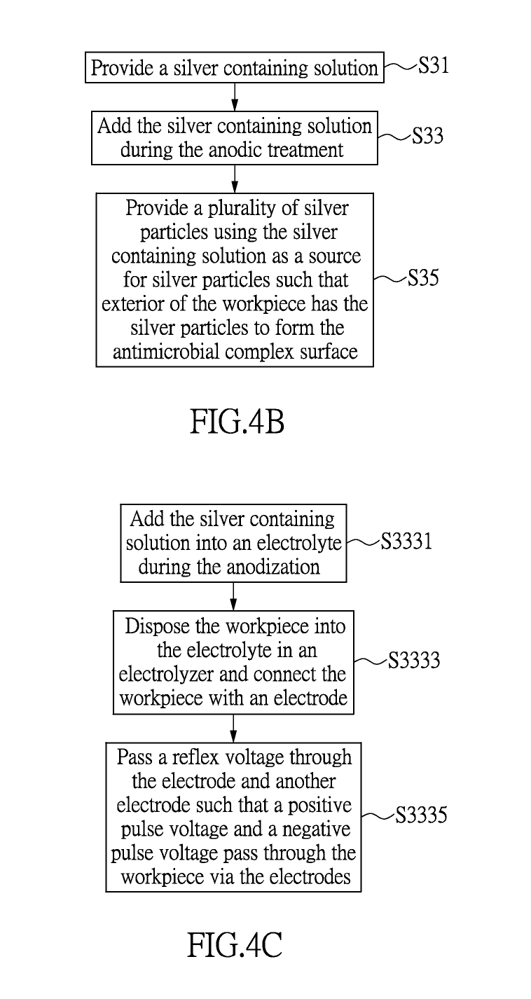

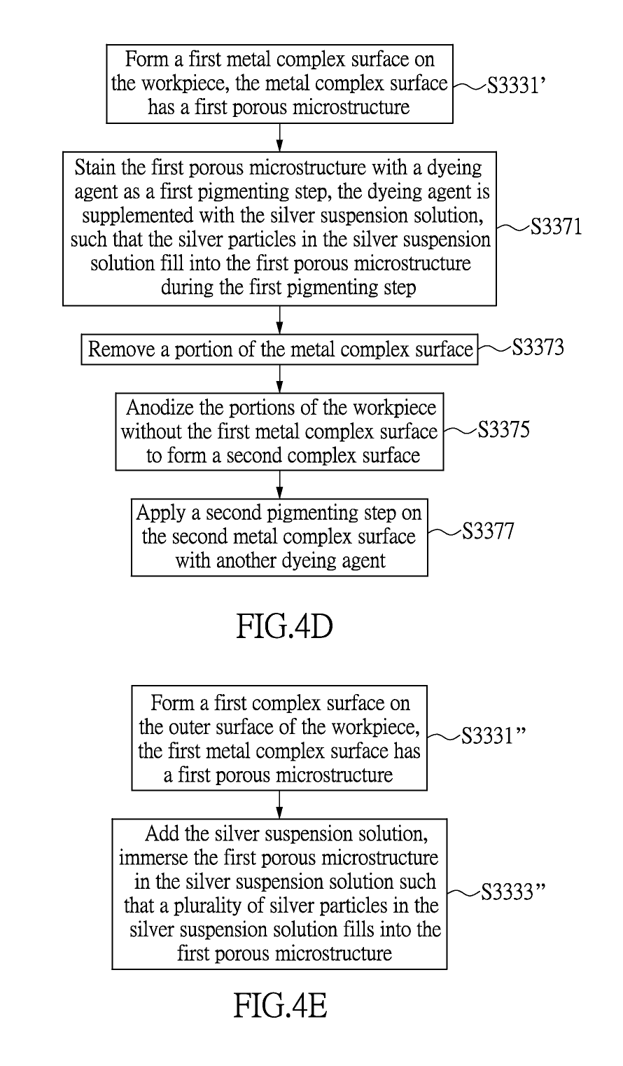

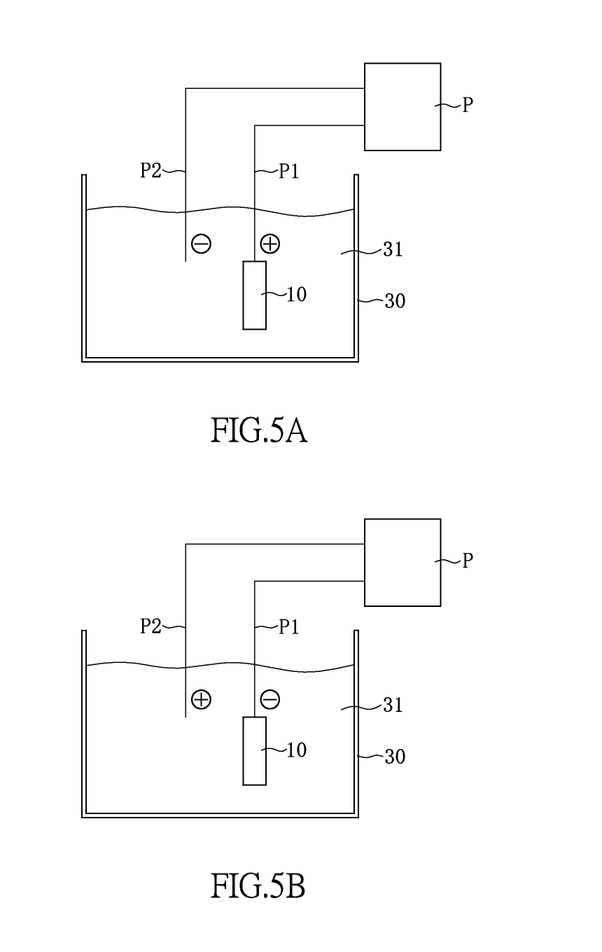

Please refer to FIGS. 4A and 4B. The instant disclosure provides a method to form an antimicrobial complex surface, which is mainly performed during the process of anodic treatment S330. The anodic treatment S330 includes the following steps that are performed on a workpiece (not shown) in sequence: pretreatment (Step S331), anodization (Step S333), acid pickling (Step S335), staining (Step 337), and sealing (Step 339). The processing method for the antimicrobial complex surface includes at least the following steps: provide a silver containing solution (Step S31), add the silver containing solution during the anodic treatment S330 (Step S33), and provide a plurality of silver particles using the silver containing solution as a source for silver particles such that exterior of the workpiece has the silver particles form the antimicrobial complex surface (Step S35). The instant embodiment differs from the first embodiment in that the silver containing solution is not limited to be added only during the sealing step (S339).

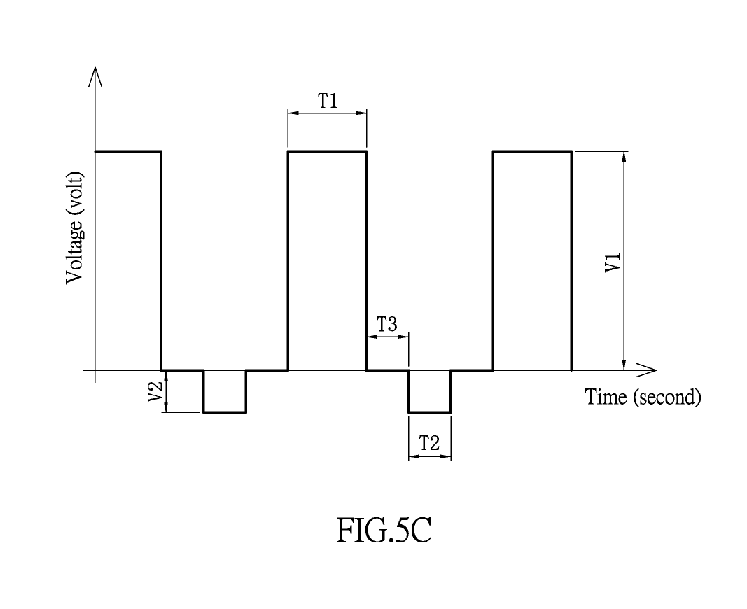

Please refer to FIGS. 4A, 4B, 4C, and 5A. Specifically, in the step of anodic treatment S330 where the silver containing solution is being added S33, a step S3331 is performed, in which the silver containing solution is added to an electrolyte 31 that will be used during the anodization (Step S333). The silver containing solution is preferably a compound solution containing silver salts such as silver chloride, silver acetate, silver nitrate, silver carbonate, silver oxalate, and similar salts. The silver salt solution has a concentration that typically ranges between 0.01M (molarity) to 0.5M with a preferred concentration at 0.05M, but is not limited therein. The silver containing solution is preferably a mixture of the silver salt containing compound and the antimicrobial additive. The antimicrobial additive can be one of the following or a mixture of at least two of the following: polyphenols, catechins, vanillin, ethyl vanillin aldehyde compounds, acyl phenyl amines, imidazoles, thiazoles, isothiazolinone derivatives, quaternary ammonium salts class, dual-gung, phenols, silver acetylacetonate, mercury, copper, cadmium, chromium, nickel, lead, cobalt, or zinc iron metal particles, mercury, copper, cadmium, chromium, nickel, lead, cobalt, or zinc iron salts, mercury, copper, cadmium, chromium, nickel, lead, cobalt, or zinc iron oxide, and is not limited to the timing when the additives are being added. The antimicrobial additive can be added during any sequence of the anodic treatment (Step S330) as needed. The electrolyte 31 can be selected from the group consisting of aqueous oxalic acid solution, aqueous phosphoric acid solution, and aqueous sulfuric acid solution, of which the concentration can range from 5 to 40%, but is not limited thereto. Aqueous sulfuric acid solution having a concentration of 20% (bulk weight percent concentration) is preferred. FIG. 5A in conjunction with FIGS. 4B, 4C, 5A, and 5B can be used as a reference to illustrate the steps involved in the anodization process. Besides step S3331, step S33 can also include the following steps: dispose the workpiece 10 into the electrolyte 31 in an electrolyzer 30 and connect the workpiece 10 with an electrode P1 (Step S3333). A reflex voltage (a reflex power supply P is responsible for providing electricity) is passed through the electrolyte 31 and the workpiece 10 that is submerged in the electrolyte 31 via the electrode P1 and another electrode P2, such that a positive pulse voltage V1 (can be referred to as a first current, not labeled) and a negative pulse voltage V2 (can be referred to as a second current, not labeled) pass through the workpiece 10 (Step S3335) in timed intervals. With regards to the positive and negative pulse voltages, when electrode P1 is the high potential electrode and the electrode P2 is the low potential electrode, the voltage generated that is applied to the workpiece 10 is defined as a positive pulse voltage V1. On the other hand, when the electrode P1 is the low potential electrode and the electrode P2 is the high potential electrode, the voltage generated that is applied to the workpiece 10 is defined as a negative pulse voltage V2. In other words, the positive and negative represents the directivity of the voltage passing though the workpiece 10, which is equivalent to the directivity of the first and second currents. As shown in FIGS. 5A and 5B, the workpiece 10 can receive power with different polarities without replacing the already connected electrodes. Please refer to the graph in FIG. 5C, the horizontal axis represents the time that the workpiece receives a positive pulse voltage V1 or a negative pulse voltage V2, whereas the vertical axis represents the voltage, the positive pulse voltage V1 (the first current) or a negative pulse voltage V2 (the second current), that is received by the workpiece 10. Stoppage time T3 is a time when no voltage or current is applied, at which time the positive pulse voltage V1 and the negative pulse voltage V2 are being switched.

As shown in FIG. 5C, the time T1 required for the positive pulse voltage V1 to pass through the workpiece 10 (in FIGS. 5A and 5B) can be longer than the time T2 required for the negative pulse voltage V2 to pass through the workpiece 10. At stoppage time T3, the workpiece 10 repeatedly receives the electrical conductivity of the positive pulse voltage V1 and the negative pulse voltage V2 in timed intervals within a unit time. In other words, the polarity of the voltage (or directivity) that is applied by the electrode P1 can be switched between positive and negative in timed intervals within a unit time. As shown in FIG. 5C, time T1 is longer than time T2. The absolute value of the positive pulse voltage V1 can be greater than that of the negative pulse voltage V2, but can also be equivalent. The active time of both can be different. Preferably regardless of polarity or directivity, the applied voltage can be 5 to 25 volts (or current at 0.2 A/dm² to 2.5 A/dm²), while the time T1, T2, and stoppage time T3 can be 0 to 254 microseconds (μs) or milliseconds (ms), all can be adjusted according to needs. As shown in FIG. 5C, regardless of the intensity of the positive and negative voltage or the time of the positive and negative voltage being applied, the workpiece 10 receives an asymmetrical positive and negative pulse voltage. Please refer to FIGS. 2A, 2B, and 2C. With the previous steps, the intensity of the positive pulse voltage V1, and the time received by the workpiece 10, are relatively stronger and longer, respectively. Consequently, the workpiece 10 is oxidized to form the first metal complex surface 11 that has the first porous microstructure 11a. Meanwhile, when the workpiece 10 is receiving the negative pulse voltage V2, the silver containing solution that is already added to the electrolyte earlier facilitates the silver ions in the silver containing solution to receive electrons provided by the negative pulse voltage V2 and revert back to silver particles. As a result, the silver particles are distributed on the exterior of the workpiece 10, and the antimicrobial complex surface is formed via the distribution of silver particles with an oxidizing film being formed on the exterior of the workpiece 10. Subsequent steps, acid pickling (Step S335), staining (Step S337), and sealing (Step S339) are performed. While technical details of step S335 and S337 can be referred to in the first embodiment, the pickling step S335 can make a reference to the first acid pickling and second acid pickling in the pretreatment procedures of the first embodiment, thus, acid pickling is not limited only to the pretreatment process.

Please refer to FIGS. 2B, 2C, 4A, 4B, and 4D. The silver containing solution can be the silver suspension solution in the first embodiment. When the silver containing solution is being added in the process of anodic treatment (S330), the following steps can also be included: perform the anodic treatment (Step S333) to form the first metal complex surface 11 on the outer surface of the workpiece 10. The first metal complex surface 11 has a first porous microstructure 11a (Step S3331′). Successively, after acid pickling S335 (not shown in FIG. 4D), the following steps regarding staining S337 are performed. The first pigmenting step is performed on the first porous microstructure 11a with a dyeing agent. The dyeing agent can be added with the silver suspension solution (Step S3371) so that the silver particles 20 of the silver suspension solution are distributed to enter and fill in the first porous microstructure 11a during the first pigmenting step. As a result, the metal complex surface 11 has a first color after the first pigmenting step. In other words, the first metal complex surface 11 can include the first color layer 110, and the silver particles 20 can be in the first color layer 110. Subsequently, the sealing step takes place (Step S339, not shown in FIG. 4D, please refers to 4A).

Please refer to FIGS. 2C, 3, and 4D. In order to stain the workpiece 10 once more and introduce silver particles 20 at the staining step, sealing can be held off in the step S3371, and can further include at least the following steps: remove a portion of the first metal complex surface 11 (Step S3373). Then the portions of the workpiece 10 where the first metal complex surface 11 is non-existent can be anodized to form the second metal complex surface 11′ of the second porous microstructure 11a′ (Step S3375). The second pigmenting step (Step S3377) is performed on the second metal complex surface 11′ with another dyeing agent. The other dyeing agent can also include the silver suspension solution, so that the silver particles 20 can fill in the second porous microstructure 11a′ during the second pigmenting step, and the second porous microstructure 11′ can have a second color due to the second pigmenting step. In other words, the second metal complex surface 11′ can include the second color layer 110′, and the silver particles 20 can be in the second color layer 110′. Once staining or coloring is complete, sealing can take place accordingly. Silver can be introduced during the sealing as aforementioned in the first embodiment to form the antimicrobial complex surface on the workpiece 10 in order to enhance antimicrobial effect. Silver particles 20 that are introduced to the sealing layer 12 as well as the silver suspension solution that are used in the second embodiment have already been disclosed in the first embodiment, thus, are not further disclosed.

Please refer to FIGS. 4A, 4B, and 4E. After the first porous microstructure 11a is formed, the workpiece 10 can be directly immersed into the silver suspension solution with the option to include the antimicrobial additives therein. Please refer to FIGS. 2A, 2B, and 2C. The first metal complex surface 11 is formed on the outer surface of the workpiece 10, and the first metal complex surface 11 has the first porous microstructure 11a (Step S3331″). Subsequently, the silver suspension solution is added so that the first porous microstructure 11a is immersed into the silver suspension solution, and the silver particles 20 in the silver suspension solution enter and fill into the first porous microstructure 11a (Step S3333″). The above steps can be performed before staining S337. However, the dyeing agent can be added to the silver suspension solution or the silver suspension solution with the antimicrobial additive depending on the case during staining. Please refer to FIG. 3. Similarly, before the second pigmenting step, the second porous microstructure 11a′ can be immersed into the silver suspension solution, so that the silver particles 20 of the silver suspension solution enter and fill into the second porous microstructure 11a′. The steps in this section are not limited to be performed before or after acid pickling S335.

Please refer to FIG. 3 for adjustments made to the above processing method. The instant disclosure further provides an antimicrobial complex surface that is formed on the outer surface of the workpiece 10. The surface includes at least a plurality of silver particles and an anodized first metal complex surface 11. The first metal complex surface 11 is distributed on the outer surface of the workpiece 10 according to a first distribution region D1. The first metal complex surface 11 has a first porous microstructure 11′. The silver particles 20 are distributed on the workpiece 10 along the first distribution region D1. Preferably, the silver particles 20 are located on the first metal complex surface 11. The silver particles can also be located in the first porous microstructure 11a. The antimicrobial complex surface can also include a sealing layer 12 that is entrained with the silver particles 20, formed on the first metal complex surface 11, and seals the first porous microstructure 11a. The sealing layer 12 can be made from a nickel acetate based sealing agent. Preferably, the first metal complex surface 11 can also have a first color layer 110. In other words, the first metal complex surface 11 can have a first color.

As shown in FIG. 3, the instant disclosure can also include a second metal complex surface 11′ that is distributed on the outer surface of the workpiece 10 according to a second distribution region D2. The second metal complex surface 11′ can also have a second porous microstructure 11a′. The silver particles 20 can be located on the second metal complex surface 11′ or the second porous microstructure 11a′. Alternatively, the sealing layer 12 can also be entrained with silver particles 20, formed on the second metal complex surface 11′, and seal the second porous microstructure 11a′. Moreover, the antimicrobial additive can be mixed in with the silver particles 20 for processing as shown in FIG. 3, so the antimicrobial additive (not shown or labeled) can be in the first porous microstructure 11a of the first metal complex surface 11 and the second porous microstructure 11a′ of the second metal complex surface 11′ or directly on the first metal complex surface 11 and the second metal complex surface 11′. Alternatively, the antimicrobial additive can be mixed into the sealing layer 12, so the sealing layer 12 seals into the first porous microstructure 11a or the second porous microstructure 11a′. With regards to staining, the second metal complex surface 11′ can also include a second color layer 110′. In other words, the second metal complex surface 11′ has a second color. The antimicrobial additive plays a role an antimicrobial material in the antimicrobial complex surface. The antimicrobial additive can be placed in the antimicrobial complex surface in terms of relative position in the structure. The antimicrobial complex surface and the method for forming the surface of the instant disclosure are mainly generated by mutual comparison, modification, or combination of the technical contents from the first embodiment of the second embodiment, so that the first embodiment and the second embodiment can be mutually referenced, used, combined to produce a preferred embodiment of the instant disclosure. However, the above descriptions are only preferred embodiments of the instant disclosure, any changes or modifications made equivalent to the patentable scope of the instant disclosure are also under the scope of the instant disclosure.

The figures and descriptions supra set forth illustrate the preferred embodiments of the instant disclosure; however, the characteristics of the instant disclosure are by no means restricted thereto. All changes, alterations, combinations or modifications conveniently considered by those skilled in the art are deemed to be encompassed within the scope of the instant disclosure delineated by the following claims.

What is claimed is:

1. A method to form an antimicrobial complex surface on a workpiece during an anodic treatment, and the process including the steps comprising:
pretreating the workpiece;
anodizing the workpiece;
acid pickling the workpiece;
staining the workpiece;
pole sealing the workpiece;
providing a silver containing solution;
adding the silver containing solution during the anodic treatment; and
providing a plurality of silver particles with the silver solution as a source of silver particles so that at least an outer surface of the workpiece has the silver particles to form the antimicrobial complex surface.

2. The method as recited in claim 1, wherein in the step of adding the silver containing solution during the anodic treatment, the silver containing solution is added into an electrolyte.

3. The method as recited in claim 1, wherein the silver containing solution is a salt solution containing silver.

4. The method as recited in claim 3, wherein the salt solution containing silver is selected from the group consisting of silver acetate, silver chloride, silver nitrate, and the combination thereof.

5. The method as recited in claim 2, wherein the electrolyte is selected from the group consisting of aqueous oxalic acid solution, aqueous phosphoric acid solution, aqueous sulfuric acid solution, and the combination thereof.

6. The method as recited in claim 2, wherein the anodizing process further comprising the steps of:
arranging the workpiece into the electrolyte in an electrolyzer, and connecting the workpiece to an electrode; and
passing a reflex voltage through the electrode and another electrode such that a positive pulse voltage and a negative pulse voltage pass through the workpiece via the electrodes.

7. The method as recited in claim 5, wherein the positive pulse voltage passes through the workpiece for a period of time longer than the time the negative pulse voltage passes through the workpiece.

8. The method as recited in claim 5, wherein the positive pulse voltage and the negative pulse voltage are absolute values, and the absolute value of the positive pulse voltage is greater than the absolute value of the negative pulse voltage.

9. The method as recited in claim 1, wherein the silver containing solution is a silver suspension solution, and in the step of adding the silver containing solution during the anodic treatment, further comprising:
anodizing the workpiece to form a metal complex surface on the outer surface of the workpiece; wherein the first metal complex surface has a first porous microstructure arranged thereon; and
adding the silver suspension solution and immersing the first porous microstructure in the silver suspension solution such that the plurality of silver particles in the silver suspension solution fills into the first porous microstructure.

10. The method as recited in claim 1, wherein the silver containing solution is a silver suspension solution, and in the step of adding the silver containing solution during the anodic treatment, further comprising:
anodizing the workpiece to form a metal complex surface on the outer surface of the workpiece; wherein the first metal complex surface has a first porous microstructure arranged thereon; and
staining the first porous microstructure with a dyeing agent as a first pigmenting step; wherein the dyeing agent is supplemented with the silver suspension solution such that the plurality of silver particles in the silver suspension solution fills into the first porous microstructure during the first pigmenting step.

11. The method as recited in claim 10, further comprising:
removing a portion of the first metal complex surface;
anodizing portions of the workpiece without the first metal complex surface to form a second complex surface, and the second complex surface having a second porous microstructure arranged thereon; and
applying a second pigmenting step on the second metal complex surface with one other dyeing agent;
wherein the silver suspension solution is added to the other dyeing agent, so that the plurality of silver particles fills into the second porous microstructure during the second pigmenting step.

12. The method as recited in claim 9, wherein the silver suspension solution further comprises an anionic surfactant, the anionic surfactant has a first weight percent with respect to the silver suspension solution, and the first weight percent is between 0 to 8%.

13. The method as recited in claim 12, wherein the anionic surfactant is sodium dodecylbenzenesulfonate or sodium dodecyl sulfate.

14. The method as recited in claim 9, wherein the silver suspension solution is prepared by the steps comprising:
preparing a molar concentration ranging from 0.01 M to 0.1 M of silver nitrate solution;
adding a polyvinylpyrrolidone copper to the silver nitrate solution; wherein the polyvinylpyrrolidone silver has a weight percent ranging from 0.027% to 0.054% with respect to the silver nitrate solution;
trickling in dropwise the silver nitrate solution into a sodium borohydride solution to gradually precipitate out the silver particles; wherein the sodium borohydride has a molar concentration ranging from 0.00846M to 0.01M;
rinsing the remaining polyvinyl pyrrolidone off from the silver particles with an organic solvent;
evaporating the organic solvent on the silver particles; and
adding the silver particles into an aqueous suspension to obtain the silver suspension solution.

15. The method as recited in claim 14, wherein the step of trickling in dropwise the silver nitrate solution into a sodium borohydride solution, trickling is performed between 4 to 13° C.

16. The method as recited in claim 14, wherein the organic solvent is methanol or ethanol.

17. The method as recited in claim 14, wherein the step of evaporating the organic solvent on the silver particles further comprising:
vacuum distilling to supplement the evaporation of the organic solvent.

18. The method as recited in claim 1, wherein the silver containing solution further comprising an antimicrobial additive, and the additive is selected from the group consisting of polyphenols, catechins, vanillin, ethyl vanillin aldehyde compounds, acyl phenyl amines, imidazoles, thiazoles, isothiazolinone derivatives, quaternary ammonium salts class, dual-gung, phenols, silver acetylacetonate, mercury, copper, cadmium, chromium, nickel, lead, cobalt, or zinc iron metal particles, mercury, copper, cadmium, chromium, nickel, lead, cobalt, or zinc iron salts, mercury, copper, cadmium, chromium, nickel, lead, cobalt, or zinc iron oxide, and the combinations thereof.

19. The method as recited in claim 9, wherein the silver containing solution further comprising an antimicrobial additive, and the additive is selected from the group consisting of polyphenols, catechins, vanillin, ethyl vanillin aldehyde compounds, acyl phenyl amines, imidazoles, thiazoles, isothiazolinone derivatives, quaternary ammonium salts class, dual-gung, phenols, silver acetylacetonate, mercury, copper, cadmium, chromium, nickel, lead, cobalt, zinc, or iron metal particles, mercury, copper, cadmium, chromium, nickel, lead, cobalt, or zinc iron salts, mercury, copper, cadmium, chromium, nickel, lead, cobalt, or zinc iron oxide, and the combinations thereof.

20. An antimicrobial complex surface formed on an outer surface of a workpiece, comprising:
a first metal complex surface anodized; and
a plurality of silver particles distributed on the workpiece along a first distribution region;
wherein the first metal complex surface is distributed on the outer surface of the workpiece according to the first distribution region, and the first metal complex surface has a first porous microstructure arranged thereon.

21. The method as recited in claim 20, wherein the silver particles are disposed on the first metal complex surface.

22. The method as recited in claim 20, wherein the silver particles are in the first porous microstructure of the first metal complex surface.

23. The method as recited in claim 20, wherein the antimicrobial complex surface further comprises a sealing layer entrained with the silver particles, and the sealing layer formed on the first metal complex surface to seal the first porous microstructure.

24. The method as recited in claim 23, wherein the sealing layer is formed by a nickel acetate-based sealing agent.

25. The method as recited in claim 23, wherein the first metal complex surface further comprises a first color layer.

26. The method as recited in claim 23 further comprising
a second metal complex surface distributed on the outer surface of the workpiece according a second distribution region, the second metal complex surface having a second porous microstructure arranged thereon, the sealing layer entrained with silver particles and formed on the second metal complex surface to seal the second porous microstructure.

27. The method as recited in claim 26, wherein the second metal complex surface further comprises a second color layer.

28. The method as recited in claim 20, wherein the workpiece is an aluminum or aluminum alloy workpiece.

29. The method as recited in claim 20 further comprising an antimicrobial additive distributed on the first metal complex surface.

30. The method as recited in claim 20 further comprising an antimicrobial additive distributed in the first porous microstructure of the first metal complex surface.

31. The method as recited in claim 20 further comprising:
an antimicrobial additive; and
the antimicrobial complex surface further comprising:
a sealing layer entrained with the antimicrobial additive and formed on the first metal complex surface to seal the first porous microstructure.

32. The method as recited in claim 29, wherein the antimicrobial additive is selected from the group consisting of polyphenols, catechins, vanillin, ethyl vanillin aldehyde compounds, acyl phenyl amines, imidazoles, thiazoles, isothiazolinone derivatives, quaternary ammonium salts class, dual-gung, phenols, silver acetylacetonate, mercury, copper, cadmium, chromium, nickel, lead, cobalt, or zinc iron metal particles, mercury, copper, cadmium, chromium, nickel, lead, cobalt, or zinc iron salts, mercury, copper, cadmium, chromium, nickel, lead, cobalt, or zinc iron oxide, and the combinations thereof.

33. The method as recited in claim 30, wherein the antimicrobial additive is selected from the group consisting of polyphenols, catechins, vanillin, ethyl vanillin aldehyde compounds, acyl phenyl amines, imidazoles, thiazoles, isothiazolinone derivatives, quaternary ammonium salts class, dual-gung, phenols, silver acetylacetonate, mercury, copper, cadmium, chromium, nickel, lead, cobalt, or zinc iron metal particles, mercury, copper, cadmium, chromium, nickel, lead, cobalt, or zinc iron salts, mercury, copper, cadmium, chromium, nickel, lead, cobalt, or zinc iron oxide, and the combinations thereof.

34. The method as recited in claim 31, wherein the antimicrobial additive is selected from the group consisting of polyphenols, catechins, vanillin, ethyl vanillin aldehyde compounds, acyl phenyl amines, imidazoles, thiazoles, isothiazolinone derivatives, quaternary ammonium salts class, dual-gung, phenols, silver acetylacetonate, mercury, copper, cadmium, chromium, nickel, lead, cobalt, or zinc iron metal particles, mercury, copper, cadmium, chromium, nickel, lead, cobalt, or zinc iron salts, mercury, copper, cadmium, chromium, nickel, lead, cobalt, or zinc iron oxide, and the combinations thereof.
